(19) United States
(12) Patent Application Publication
(10) Pub. No.: US 2021/0000577 A1
(43) Pub. Date: Jan. 7, 2021

(54) INTERDENTAL CLEANER

(71) Applicant: Sunstar Suisse SA, Etoy (CH)

(72) Inventor: Jürgen BUTZ, Schönau (DE)

(21) Appl. No.: 16/980,155

(22) PCT Filed: Mar. 4, 2019
(86) PCT No.: PCT/EP2019/000062

§ 371 Date: Sep. 11, 2020

(30) Foreign Application Priority Data
Mar. 16, 2018 (DE) 10 2018 002 147.6

(51) Int. Cl. A61C 15/02

(52) U.S. Cl. CPC A61C 15/02

(57) ABSTRACT

An interdental cleaner with a rod-shaped carrier which is made of a first plastics material and extends along a longitudinal axis. At its front end, the rod-shaped carrier has a cleaning part in the form of a cover made of a soft elastic plastics material. A handle part is arranged at the rear end of the carrier which is opposite the front end. A connecting section of the carrier which exhibits a significantly greater deformation under certain conditions is formed between the handle part and the cover.

The invention relates to an interdental cleaner with a rod-shaped carrier which is made of a plastics material and extends along a longitudinal axis, the rod-shaped carrier having a cleaning part in its front end section in the form of a cover made of a soft elastic plastics material, a handle part being arranged in a rear end section of the carrier which is axially opposite the front end section.

Such an interdental cleaner, which is also referred to as a toothpick, is known, for example, from EP 0 932 371 Bl. The interdental cleaner shown there has a rod-shaped carrier made of a dimensionally stable plastics material, at the rear end of which a handle part is integrally formed via a connection region. In its front end region facing away from the handle part, the carrier is provided with a soft elastic cover which can be designed with radially projecting structural elements and which forms a cleaning part. To clean the interdental spaces, the user grasps the interdental cleaner on the handle part and inserts the front end of the carrier and thus the cleaning part into the interdental space and moves the interdental cleaner back and forth.

Similar interdental cleaners are also known from DE 10 2012 015 664 A1, DE 10 2013 010 782 A1, DE 10 2016 005 012 A1, EP 3 245 977 A1 and WO 2017/104784 A1.

It has been shown that the cleaning effect depends substantially on the way in which the user guides the interdental cleaner within the interdental space. The alignment of the interdental cleaner is substantially determined by how the user arranges the handle part relative to the interdental space to be cleaned. Although the carrier has a certain elasticity and can be elastically deformed if a particular inclination of the cleaning section within the interdental space is necessary, this can only be achieved if the user aligns the entire interdental cleaner appropriately, which is difficult to achieve in some cases.

The object of the invention is to create an interdental cleaner of said type which enables the cleaning part to be positioned more variably within the interdental space.

The object is achieved by an interdental cleaner having the features of claim 1. This provides a rod-shaped carrier made of a plastics material, which extends along a longitudinal axis, the rod-shaped carrier having a cleaning part in its front end section in the form of a cover made of a soft elastic plastics material, a handle part being arranged in a rear end section of the carrier which is axially opposite the front end section, and the carrier having, outside the cleaning part, a deformation section that exhibits significantly greater deformation under the following conditions:
if the interdental cleaner is firmly clamped in a clamping plane by means of a clamping device at a distance of 10 mm from its rear axial end in the region of the handle part perpendicular to the longitudinal axis of the carrier, and
if a cantilever section of the interdental cleaner having a cantilever section length is subdivided from the clamping plane to the cleaning part into at least eight sections of equal axial length, each section having a start point facing the handle part and an end point facing the cleaning part, and
if an external force acts on the interdental cleaner at a distance of 7 mm from its front axial end in such a way that the interdental cleaner is elastically deflected in the load action point P_{F} by a distance of 8 mm perpendicular to the longitudinal axis of the carrier, and
if the x-coordinate along the longitudinal axis of the interdental cleaner and the y-coordinate in the direction of action of the external force are determined on the deformed interdental cleaner for each start point and end point of the sections, and
if a straight section line which runs through the start point and through the end point of the respective section is calculated for each section from the x- and y-coordinates of its start point and its end point, and
if the respective smaller intersection angles are calculated in degrees between adjacent section lines,
   then the intersection angles of two or three straight section lines are at least 50% greater than the greatest intersection angle of all the other straight section lines.

In order to be able to determine the bending behavior of the interdental cleaner according to the invention in a controlled and reproducible manner, the invention requires the structure described above. It is thus possible to simulate the bending behavior and the deformations of the interdental cleaner, as they also occur during cleaning of the interdental spaces.

The invention is based on the basic idea that, in the case of the known interdental cleaners according to the prior art, in the particular application the deformations are distributed over the entire axial length of the carrier and thus cause the disadvantageous curvature of the interdental cleaner and the resulting material stresses. Almost all of the (elastic) deformation of the interdental cleaner takes place in the region of the deformation section by a targeted change in the rigidity in the deformation section of the carrier. As a result, the remaining region of the carrier is exposed to substantially lower loads. At the position of the deformation section with lower rigidity, specific precautions can be taken to safely absorb the loads that occur.

The clamping means for clamping the interdental cleaner can have two flanges which are arranged opposite one another and which move towards one another during clamping and thereby firmly clamp the interdental cleaner between them and perpendicular to its longitudinal axis. The clamping plane is thus perpendicular to the longitudinal axis of the carrier. The clamping means is preferably designed in such a way that the interdental cleaner is firmly clamped in every direction perpendicular to its longitudinal axis.

In the context of the invention the cantilever section of the interdental cleaner is defined as that region of the interdental cleaner that extends from the clamping plane to the beginning of the cleaning part. The cleaning part is thus not part of the cantilever section.

The subdivision of the cantilever section into sections is preferably such that the end point of one section coincides with the start point of the next, adjacent section. In advantageous embodiments, the sections each have an axial length of at most 2 mm, in particular at most 1 mm, in order that deformations with limited axial extent can be better resolved locally.

The external force preferably acts on the cleaning part in order to simulate the deformation behavior of the interdental cleaner when it is used. The external force acts in particular on the axial center of the cleaning part.

The x- and y-coordinates of the start points and end points of the sections can be determined, for example, by means of optical measurement methods, for example by means of a camera or measuring projector. The x-axis coincides with the longitudinal axis of the carrier and the y-axis is directed parallel to the direction of action of the external force. The two-dimensional plane spanned by the x- and y-axes is thus perpendicular to the clamping plane.

The straight line in a section with the start point aₐ(xₐ/yₐ) and the end point aₑ(xₑ/yₑ) is determined using the straight line equation: For two given points, this calculates a clearly defined straight line which runs through both points. The straight section line with the points (x_{ag}/y_{ag}) follows the equation:

y_{ag}=((yₑ−yₐ)/(xₑ−xₐ))x_{ag}+(yₐxₑ−yₑxₐ)/(xₑ−xₐ)

This equation can also be in the usual form

y_{ag}=m_{ag}x_{ag}+y_{0;ag}

where m_{ag} denotes the slope of the straight line and y_{0;ag} denotes the y-axis intercept of the straight line. y_{ag} and x_{ag} are the y- and x-coordinates of the straight section line.

According to the invention, the intersection angles are always calculated on the basis of two adjacent sections. The intersection angle α is determined between two adjacent straight section lines with slopes m_{ag1} and m_{ag2}:

α=arctan(|(m_{ag1}−m_{ag2})/(1+(m_{ag1}·m_{ag2}))|).

Angle specifications are always given in degrees (°). Intersection angles within the context of the invention are always those intersection angles smaller than 90° and are calculated on the basis of adjacent sections. The smaller and greater intersection angles always add up to 180°. In the context of the invention, the intersection angle is positive if the intersection angle corresponds to a curvature of the associated sections in the effective direction of the external force. Correspondingly, the intersection angle is negative if there is a curvature against the direction of action of the external force. If the intersection angle is equal to 0, there is no relative curvature of the sections with respect to one another.

The intersection angles of two or three straight section lines are preferably at least 80%, in particular at least 100% and preferably at least 200% greater than the greatest intersection angle of all the other straight section lines.

In a further embodiment of the invention, the intersection angles of two or three consecutive straight section lines are at least 50% greater than the greatest intersection angle of all the other straight section lines. Successive straight section lines within the context of the invention are straight section lines that are adjacent to one another.

The carrier can be designed in one piece with the handle part, so that the interdental cleaner is easy to manufacture. Alternatively, the carrier can be positively and/or non-positively connected to the handle part, so that the material of the handle part can be selected with regard to handling irrespective of the material of the carrier.

The cantilever section of the interdental cleaner is preferably divided into at least ten, in particular into at least fifteen or twenty, most preferably into at least thirty sections of equal axial length, from the clamping plane to the cleaning part.

The deformation section within the cantilever section can have the lowest flexural rigidity of the entire carrier so that, during use, the greatest deformations of the interdental cleaner occur specifically at this position. The material loads on the rest of the interdental cleaner are thereby reduced, which increases the service life of the interdental cleaner.

In particular, the reduced flexural rigidity of the deformation section is achieved by a cross-sectional weakening and/or by an at least partial use of a material with reduced flexural strength and/or by the geometry of the deformation section.

In one embodiment of the invention, the handle part is at least partially plate-shaped, the load action direction of the external force being in a direction normal to the plate plane of the handle part. The handle part is easier to grasp and handle in this embodiment. When the interdental cleaner is used it can be assumed that the external forces are mainly in a direction normal to the plate plane of the cleaning part, so that the changed rigidity has a particularly advantageous effect in this direction.

It can be provided that the deformation section is designed at least in sections in the form of a plate, the load action direction of the external force being in a direction normal to the plate plane of the deformation section. As a result, the direction for which the rigidity of the deformation section is reduced can be specified in a targeted manner. In particular, this configuration can be combined with a plate-shaped handle part, so that the plate planes of the handle part and of the deformation part are oriented parallel to one another. The deformation properties of the interdental cleaner during cleaning of the interdental spaces are optimized thereby.

Further advantages and features of the invention are apparent from the claims and from the following description, in which exemplary embodiments of the invention are explained in detail with reference to the drawings. In the drawings:

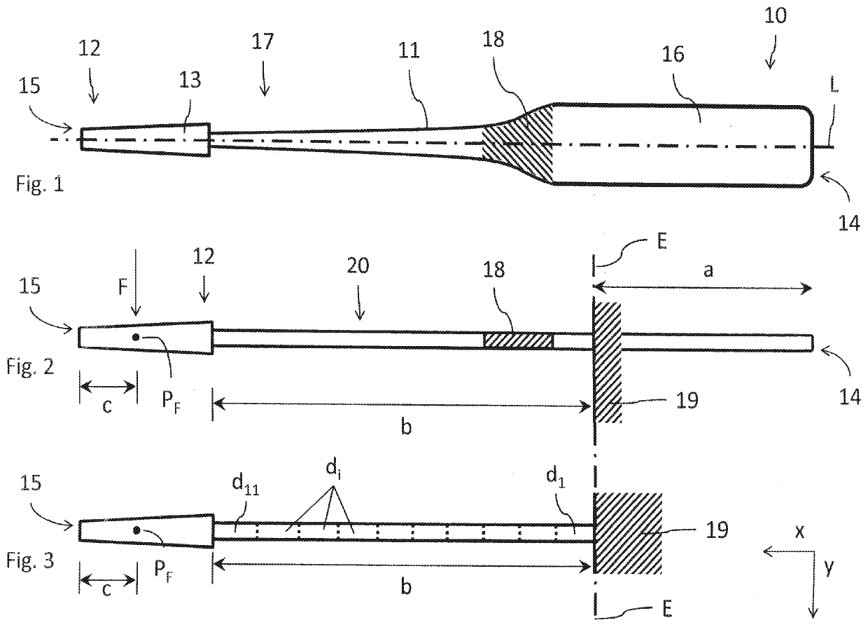

FIG. 1 is a schematic top view of an interdental cleaner according to the invention;

FIG. 2 is a side view of the interdental cleaner from FIG. 1 in the clamped state;

FIG. 3 shows the interdental cleaner from FIG. 2 with a subdivided cantilever section;

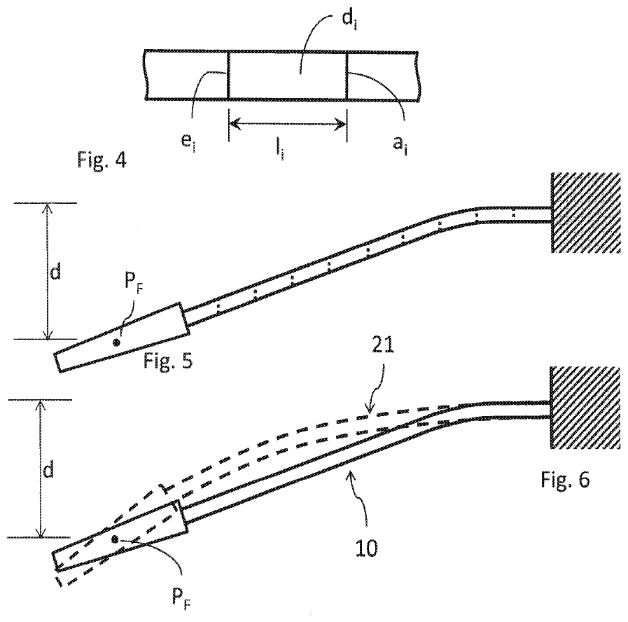

FIG. 4 shows an enlarged illustration of a partial region from FIG. 3;

FIG. 5 shows the interdental cleaner of FIGS. 2 and 3 in a deflected state;

FIG. 6 shows the deflected interdental cleaner from FIG. 5 and an interdental cleaner from the prior art in a deflected state and

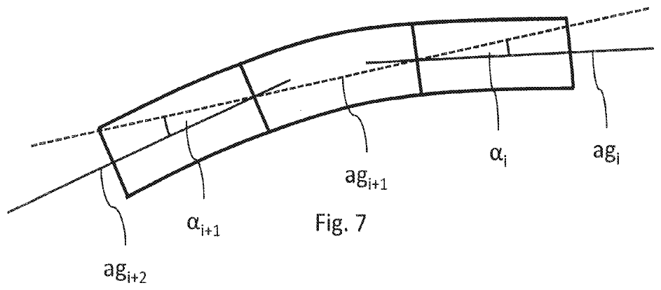

FIG. 7 is an enlarged illustration of the partial regions of the interdental cleaner from FIG. 6 for calculating the intersection angle.

FIG. 1 shows a schematic plan view of an interdental cleaner 10 according to the invention with a rod-shaped carrier 11 made of a first plastics material. The carrier 11 extends along a longitudinal axis L, shown in dashed lines in FIG. 1, which runs horizontally as shown in FIG. 1. In its front end section, on the left according to FIG. 1, the carrier 11 has a cleaning part 12 in the form of a cover 13 made of a soft elastic plastics material. A large number of radially projecting fingers and/or bristles, which are not shown for reasons of clarity, are usually arranged on the cover 13. Radial directions within the context of the invention are perpendicular to the longitudinal axis L of the carrier 11. The fingers and/or bristles serve for cleaning of interdental spaces.

A plate-shaped handle part 16 is arranged on a rear end section of the carrier 11 opposite the cover 13, the plane of the plate being parallel to the drawing plane. The user usually grips the handle part 16 between thumb and forefinger, the plate-like configuration enabling simple handling and preventing unwanted rotation of the interdental cleaner 10.

The interdental cleaner 10 is delimited in the longitudinal direction by its rear axial end 14 which corresponds to the rear axial end of the handle part 16, and by its front axial end 15 which corresponds to the front axial end of the cover 13.

Between the handle part 16 and the cover 13, the carrier 11 has a trapezoidal configuration which tapers in the direction of the front axial end 15.

In a section facing the handle part 16 and outside the cleaning part 12, the carrier 11 has a deformation section 18 with a significantly lower rigidity compared to the rest of the connection region 17 of the carrier 11 in order to specifically influence the flexural behavior of the interdental cleaner 10. In the illustrated exemplary embodiment, the deformation section lies in the trapezoidal region in which the handle part 16 merges into the carrier 11. In contrast to the deformation section 18, the rigidity of the remaining connection region 17 of the carrier 11 changes only to a small extent due to the configuration which tapers towards the cleaning part 12.

In the exemplary embodiment in FIG. 1, the lower rigidity of the deformation section 18 is achieved in that the deformation section 18 is made of a different material than the rest of the connection region 17 of the carrier 11. Additionally or alternatively, the cross section of the deformation section 18 is tapered towards the cleaning part 12, which also reduces the rigidity. Both the choice of material and the cross-sectional tapering can be provided independently of one another or also in combination with one another within the context of the invention. Additionally or alternatively, other possibilities for influencing can be provided, for instance by a special design of the geometry of the deformation section 18.

The structure shown in a side view in FIG. 2 is suitable for assessment of the rigidity of the interdental cleaner 10 and its deformation behavior under a given load: The interdental cleaner 10 is firmly clamped by means of a clamping means 19. The clamping means 19 is, for example, a clamping element with two opposing flanges which receive the interdental cleaner 10 between them and clamp it within a clamping plane E. The clamping plane E is perpendicular to the longitudinal axis L of the carrier 11 and intersects the interdental cleaner 10 at a distance a of 10 mm from its rear axial end 14, as shown in FIG. 2.

The part of the interdental cleaner 10 which projects freely from the clamping means 19 between the clamping plane E and the cleaning part 12 forms a cantilever section 20 with an axial cantilever section length b. The deformation section 18 is shown hatched in FIG. 2 and is part of the cantilever section 20. The cleaning part 12 is not part of the cantilever section.

The cantilever section 20 of the clamped interdental cleaner 10 is divided according to FIG. 3 into 11 sections dᵢ with the same axial length lᵢ, the index i being a natural number for the corresponding section (FIG. 4). In this case the section d₁ is always the section d₁ that is closest to the clamping plane E. The numbering then takes place with increasing distance from the clamping plane E. Consequently section d₁₁ is closest to the cleaning part 12.

Each section dᵢ has a start point aᵢ facing the handle part 16 and an end point eᵢ facing the cleaning part 12 (FIG. 4). In the case of two adjacent sections dᵢ, dᵢ₊₁, the end point eᵢ of the axially rear section dᵢ corresponds to the start point aᵢ₊₁ of the axially front section dᵢ₊₁.

At a distance c of 7 mm from the front axial end 15 of the interdental cleaner 10, an external force F acts downwards on the load action point P_{F}Of the cleaning part 12 (FIGS. 2 and 3) perpendicular to the longitudinal axis L of the carrier 11 in such a way that the load action point P_{F} is elastically deflected by a distance d of 8 mm perpendicular to the longitudinal axis L of the carrier 11. Under the influence of the external force F the interdental cleaner 10 assumes the curved shape shown in FIG. 5. It can be seen from FIG. 5 that the predominantly large proportion of the deformation of the interdental cleaner 10 takes place in the region of the deformation section 18, while the remaining connection region 17 of the carrier 11 is only slightly curved or remains largely straight.

For each section dᵢ, its respective start points aᵢ and its end points eᵢ are determined. The points consist of assigned x- and y-coordinates, the x-axis coinciding with the longitudinal axis L of the carrier 11 and the y-axis being directed parallel to the direction of action of the external force F. The coordinates are determined, for example, by means of a camera with a sufficiently high resolution that allows the determination of the coordinates in the order of 100 μm, preferably 10 μm.

For each section dᵢ a straight section line agᵢ associated with the section dᵢ is calculated, which runs through the start point aᵢ and through the end point eᵢ of the section dᵢ. For each section dᵢ the straight section line agᵢ is uniquely determined by

y_{ag;i}=((y_{e;i}−y_{a;i})/(x_{e;i}−x_{a;i}))x_{ag;i}+(y_{a;i}x_{e;i}−y_{e;i}x_{a;i})/(x_{ei;}−x_{a;i})

where x_{ag;i} and y_{ag;i} represent the x- and y-coordinates of the straight section line agᵢ. This also applies analogously to the start point aᵢ(x_{a;1}/y_{a;1}) and the end point eᵢ(x_{e;i}/y_{e;i}). The straight section line agᵢ runs through the start point aᵢ and the end point eᵢ of the segment dᵢ.

From the alternative notation of the straight section line

y_{ag;1}=m_{ag;i}x_{ag;1}+y_{0;ag;i}

the slope m_{ag;i} of the straight section line agᵢ can be seen. The following applies here:

m_{ag;i}=(y_{e;i}−y_{a;i})/(x_{e;i}−x_{a;i})

The intersection angle α is then calculated for two adjacent sections dᵢ, dᵢ₊₁ and the corresponding slopes m_{ag;i}, m_{ag;i+1} of the respective straight section line agᵢ, agᵢ₊₁ as

α=arctan(|(m_{ag;i}−m_{a;i+1})/(1+(m_{ag;i}·m_{ag;i+1}))|)

which is also evident from FIG. 7.

The intersection angle α characterizes the curvature behavior of the cantilever section 20 within a section dᵢ and is positive within the context of the invention if the cantilever section 20 is curved in the direction of the external force F. The intersection angle α is negative if there is a curvature against the direction of the external force F. The intersection angle α is equal to 0 if there is no curvature in the section dᵢ.

FIG. 5 shows that the second region d₂ and the third region d₃ have a substantially greater curvature than the other regions. Consequently, the associated intersection angles α are significantly greater than the greatest intersection angle α of the remaining sections dᵢ, which means in the context of the invention that the two greatest intersection angles α are at least 50% greater than the greatest intersection angle α of the remaining sections dᵢ or the next greater intersection angle.

In FIG. 6, the interdental cleaner 10 according to the invention is shown in a deformed state by solid lines. For comparison, a known interdental cleaner 21 according to the prior art is shown in a deformed state by broken lines. In contrast to the interdental cleaner 10 according to the invention, the known interdental cleaner 21 has a continuous curvature behavior, regions with an approximately linear configuration being completely absent. As a result of this deformation behavior, the entire carrier of the known interdental cleaner 21 is curved, which considerably reduces its useful properties. None of the intersection angles α of the known interdental cleaner 21 is, in the described context, at least 50% greater than the greatest intersection angle α of the remaining sections dᵢ.

1. An interdental cleaner comprising:
a rod-shaped carrier made of a plastics material, which extends along a longitudinal axis, the rod-shaped carrier having a cleaning part in a front end section thereof in the form of a cover made of a soft elastic plastics material, a handle part being arranged in a rear end section of the carrier which is axially opposite the front end section, and the carrier having, outside the cleaning part, a deformation section that exhibits significantly greater deformation under the following conditions:
if the interdental cleaner is firmly clamped in a clamping plane by a clamping device at a distance of 10 mm from a rear axial end thereof in a region of the handle part perpendicular to the longitudinal axis of the carrier, and
if a cantilever section of the interdental cleaner having a cantilever section length is subdivided from the clamping plane to the cleaning part into a plurality of sections of equal axial length, each of the section having a start point facing the handle part and an end point facing the cleaning part, and
if an external force acts on the interdental cleaner at a distance of 5 mm from a front axial end thereof in such a way that the interdental cleaner is elastically deflected in a load action point by a length of 8 mm perpendicular to the longitudinal axis of the carrier, and
if an x-coordinate along the longitudinal axis of the interdental cleaner and a y-coordinate in a direction of action of the external force are determined on the interdental cleaner that is deformed for each start point and end point of the sections, and
if a straight section line which runs through the start point and through the end point is calculated for each of the section from the x- and y-coordinates of the start point and the end point, and
if respective smaller intersection angles are calculated in degrees between adjacent straight section lines,
then the intersection angles of two or three straight section lines are at least 50% greater than a greatest intersection angle of all the other straight section lines.

2. The interdental cleaner according to claim 1, wherein the intersection angles of two or three straight section lines are at least 80% greater than the greatest intersection angle of all the other straight section lines.

3. The interdental cleaner according to claim 1, wherein the intersection angles of two or three straight section lines are at least 100% greater than the greatest intersection angle of all the other straight section lines.

4. The interdental cleaner according to claim 1, wherein the intersection angles of two or three straight section lines are at least 200% greater than the greatest intersection angle of all the other straight section lines.

5. The interdental cleaner according to claim 1, wherein the cantilever section of the interdental cleaner is subdivided from the clamping plane to the cleaning part into at least ten sections of the same axial length.

6. The interdental cleaner according to claim 1, wherein the cantilever section of the interdental cleaner is subdivided from the clamping plane to the cleaning part into at least fifteen sections of the same axial length.

7. The interdental cleaner according to claim 1, wherein the deformation section within the cantilever section has a lowest flexural rigidity, a flexural rigidity of the deformation section being achieved by a cross-sectional weakening and/or by an at least partial use of a material with reduced flexural rigidity and/or by the geometry of the deformation section.

8. The interdental cleaner according to claim 1, wherein the handle part is at least partially plate-shaped, a load action direction of the external force being in a direction normal to a plate plane of the handle part.

9. The interdental cleaner according to claim 1, wherein the deformation section is at least partially plate-shaped, a load action direction of the external force being in a direction normal to a plate plane of the deformation section.

10. The interdental cleaner according to claim 2, wherein the cantilever section of the interdental cleaner is subdivided from the clamping plane to the cleaning part into at least ten sections of the same axial length.

11. The interdental cleaner according to claim 2, wherein the cantilever section of the interdental cleaner is subdivided from the clamping plane to the cleaning part into at least fifteen sections of the same axial length.

12. The interdental cleaner according to claim 2, wherein the deformation section within the cantilever section has a lowest flexural rigidity, a flexural rigidity of the deformation section being achieved by a cross-sectional weakening and/or by an at least partial use of a material with reduced flexural rigidity and/or by the geometry of the deformation section.

13. The interdental cleaner according to claim 2, wherein the handle part is at least partially plate-shaped, a load action direction of the external force being in a direction normal to a plate plane of the handle part.

14. The interdental cleaner according to claim 2, wherein the deformation section is at least partially plate-shaped, a load action direction of the external force being in a direction normal to a plate plane of the deformation section.

15. The interdental cleaner according to claim 5, wherein the deformation section within the cantilever section has a lowest flexural rigidity, a flexural rigidity of the deformation section being achieved by a cross-sectional weakening and/or by an at least partial use of a material with reduced flexural rigidity and/or by the geometry of the deformation section.

16. The interdental cleaner according to claim 5, wherein the handle part is at least partially plate-shaped, a load action direction of the external force being in a direction normal to a plate plane of the handle part.

17. The interdental cleaner according to claim 5, wherein the deformation section is at least partially plate-shaped, a load action direction of the external force being in a direction normal to a plate plane of the deformation section.

18. The interdental cleaner according to claim 7, wherein the handle part is at least partially plate-shaped, a load action direction of the external force being in a direction normal to a plate plane of the handle part.

19. The interdental cleaner according to claim 7, wherein the deformation section is at least partially plate-shaped, a load action direction of the external force being in a direction normal to a plate plane of the deformation section.
